(19) United States
(12) Patent Application Publication
(10) Pub. No.: US 2026/0370643 A1
(43) Pub. Date: Nov. 19, 2026

(54) MANAGEMENT OF APPLICATIONS AND APPLICATION INFRASTRUCTURE THROUGH A CONTROL PLANE FOR A MESH NETWORK OF DEVICES

(71) Applicant: PAYPAL, INC., San Jose, CA (US)

(72) Inventors: Aravind Amarambedu Parandhaman, Fulshear, TX (US); Gabriel Alejandro Garoz González, Guatemala City (GT); Tulasi Ram Kavuri, Milpitas, CA (US); Jesus Alberto Guzman, Villa Nueva (GT)

(21) Appl. No.: 19/208,172

(22) Filed: May 14, 2025

(51) Int. Cl. H04L 9/40; H04L 67/12

(52) U.S. Cl. CPC H04L 63/0869; H04L 63/029; H04L 63/0823; H04L 67/12

(57) ABSTRACT

There are provided systems and methods for management of applications and application infrastructure through a control plane for a mesh network of devices. A service provider, including an electronic transaction processor, may provide certificate rotations and other updates and maintenance for software application infrastructure components and data through a control mesh provided through a mesh network of devices. A data source, such as a certificate authority, may use a control plane to organize and schedule data handling and routing in a data plane for a mesh network of the devices. The devices may utilize zero-trust tunnels for encrypted messaging between copies of an application on the devices. The certificate authority may update digital certificates with each copy of the application on each device in the mesh network. The updated digital certificates may then continue use for secure tunnel establishment and data exchange between devices in the mesh network.

### TECHNICAL FIELD

The present application generally relates to automated software application management and updating and more particularly to performing operations to update and manage software application features and data with minimal service interrupt and manual user actions.

### BACKGROUND

Service providers may have large computing systems that provide computing services to entities and individual users, such as customers, clients, merchants, and the like. Users may interact with various websites and their digital platforms via computing devices, which may utilize device-side native software applications to interact with the service provider. For example, it has become more common for online transaction processors and other financial services entities to provide mobile applications where users may engage in electronic transaction processing and other digital payment or financial services. Machines used by mobile applications for server-side processing may include cloud computing systems where servers may run multiple instances of applications and serve multiple consumers or tenants at once. However, other types of computer networking environments may include virtual machines (VMs) and/or bare-metal servers running a single instance of an application for a consumer/tenant or may only run applications for a specific consumer or tenant and their device, server, system, or the like.

For example, in a conventional situation where server-side updates may be triggered, mobile applications may be updated through routine downloads of the mobile applications and/or assets and software components of the mobile application (e.g., application patches), which takes time and requires network connectivity. For service providers, these migrations, updates, and configuration changes may occur across thousands of applications, each requiring significant developer hours and context switching, making prioritization of certain applications and/or platforms difficult. However, without consistently updating security protocols, such as security certificates for applications, performance may degrade and private or sensitive data, such as financial data, may encounter security risks. Thus, it is desirable for service providers to implement an automated system to manage software application infrastructure requirements independently from requiring full application updates while maintaining reliability, scalability, and security of application security protocols.

### BRIEF DESCRIPTION OF THE DRAWINGS

FIG. 1 is a block diagram of a networked system suitable for implementing the processes described herein, according to an embodiment;

FIGS. 2A and 2B are exemplary diagrams of secure tunnels between machines that may be used on a mesh network for application management and updates, according to an embodiment;

FIGS. 3A and 3B are exemplary system architectures where digital certificates for security protocols and data are updated on machines for a software application managed through a control plane of a mesh network, according to an embodiment;

FIG. 4 is a flowchart for management of applications and application infrastructure through a control plane for a mesh network of devices, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for management of applications and application infrastructure through a control plane for a mesh network of devices. Systems suitable for practicing methods of the present disclosure are also provided.

When using computing platforms, websites, and online resources of service providers, the service provider may provide native software applications residing locally on computing devices of users. For example, mobile applications and other device-side software applications may be developed and provided as dedicated applications for that service provider and enable users to utilize a suite of different software functionalities and application processes. Other types of desktop or laptop personal computers (PCs), servers, and the like may have applications that provide similar functionalities. A user may utilize their particular device to authenticate and/or login to an account through such the application, where the application may then allow the user to engage with the service provider and/or other users and entities through the suite of application functionalities and processes. Application development may be performed by one or more application developers of the service provider, such as one or more teams of software developers, coders, testers, and the like, who may be responsible for application creation, as well as application maintenance and updating.

However, as the complexity of software applications and other dedicated software applications increases, application teams may spend more and more time working on the development of the functional concerns of the application. Service providers may require updates to core functionalities to enable new and emerging technologies and demands of users. Concurrent with these demands, certain application data and updates, such as the security protocols and other application infrastructure necessary and/or utilized for secure communications and/or interactions (e.g., performing a security handshake or otherwise establishing a secure communication channel, trust relationship for data exchanges, and the like), may also require constant maintenance and updates to prevent security risks. These risks may include unauthorized or malicious entities compromising encryption keys, digital security certificates, login credentials, or other security mechanisms designed to ensure secure communications, data exchanges, data processing, and/or user, device, or account authentication and/or verification. These updates to the application infrastructure, however, may also be handled separately from application development teams and users since the data and updates being managed are not directly tied to changing or adding application functionalities.

To minimize the impact of updating security certificates used during secure data exchange and processing, as well as perform other application maintenance and updates associated with application infrastructure, the service provider, in some embodiments, may utilize a mesh network of devices controlled or managed through a control plane of the devices and connecting the device through a control plane. This mesh network may enable a central, trusted, and/or verified certificate authority (CA) to perform infrastructure management for software applications independently or separately from management of the applications and their functionalities. The mesh network may be provided for virtual machines (VMs) and/or “bare-metal” servers, or physical servers (PSs), directly running the software (e.g., where a bare-metal server may correspond to a PS that is not a virtual machine and may be used for a specific customer or tenant instead of a shared server that may be running multiple pieces of shared hardware and software and have containerized solutions for updating application instances). This ensures that security protocols stay up to date and current, and certain responsibilities and tasks, such as digital security certificate rotations, are performed with no or minimal human intervention and manual efforts. Furthermore, this may be done outside of cloud environments with containerized solutions, allowing for automated certificate rotation with the aforementioned software load on VMs and bare-metal servers.

As such, according to various embodiments, a service provider may implement an application infrastructure management system provided through a mesh network of devices that manages infrastructure updates associated with software applications where the software workload may be restricted to or performed on physical servers (e.g., bare-metal servers) for a single user, tenant entity, or the like and/or VMs limited to that user, entity, or the like. As such, the application infrastructure updates may be performed in a non-cloud native environment instead of containerized solutions in a cloud computing environment and cloud computing systems. Native software applications on devices, such as mobile applications on mobile smart phones, are used for various purposes including transacting with different users, entities, and service providers. In one example, an online transaction processor may provide electronic transaction processing services, including account services, user authentication and verification, digital payments, risk analysis and compliance, and the like, through a mobile application. The online transaction processor (e.g., PayPal®) may enable merchants, users, and other entities to process transactions, provide payments, provide content, and/or transfer funds between these users via software applications and other software applications. The user may also interact with the service provider to establish an account and provide other information for the user via these applications. Other service providers may also or instead provide computing services through software applications specifically designed for the business, company, and/or service, including social networking, microblogging, media sharing, messaging, business and consumer platforms, etc.

The computing services of a service provider may be availed in these applications through a user establishing an account with the service provider. An account may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like. The user may also be required to provide financial information, including payment card (e.g., credit/debit card) information, bank account information, gift card information, benefits/incentives, and/or financial investments, which may be used to process transactions for items. The online service provider may provide digital wallet services through the account, which may offer financial services to send, store, and receive money, process financial instruments, and/or provide transaction histories, including tokenization of digital wallet data for transaction processing. The application of the service provider, such as PAYPAL® or other online payment provider, may provide payments and the other transaction processing services through these applications. Further, the applications may store, access, and/or utilize private, financial, and/or sensitive information, which may require security protocols and protections for handling, transmitting, and/or processing with other applications and endpoints.

As such, a user may engage in one or more online or virtual interactions with applications of service providers, as well as other entities including merchants, social media platforms, businesses, news or information sources, and the like, for example by browsing their available data in these applications. These interactions may require use of security protocols and/or other application infrastructure to enable functionalities, as well as for different purposes including authentication and transaction processing. For example, accounts used in applications may utilize privacy protected data, such as personally identifiable information (PII), financial data, health data, transaction data and/or histories, know your client (KYC) data, and the like. Similarly, application processes and activities facilitated through the applications may access, use, and/or transmit such data. As such, application infrastructure is required to be updated and maintained so that security protocols do not become compromised. A service provider may utilize the mesh network of devices, as described herein, to facilitate such infrastructure maintenance using a data source for application updates that connects with devices via a control plane and proxies of the devices. In turn, this may allow the devices to manage application updates through a control plane that may be integrated into the infrastructure of the application and utilizes zero-trust tunnels to securely connect and authenticate elements on the network or data mesh. As such, devices may be capable and responsible for updating other devices without requiring a central controller to manage, send, and confirm updates and other changes to application infrastructure.

In this regard, an application may be configured to establish zero-trust tunnels or other secure communication tunnels using a security protocol that enables zero-trust relationships and connections to be established between different devices and their copies or “instances” of the application. The application may be developed to incorporate a security protocol and processes to connect, either periodically or continuously when network connectivity is available, to a data source, such as a certificate authority that may rotate digital certificates for security protocols, encryption keys and/or secrets, or other digital file or electronic password that proves the authenticity of a device and/or the application of the service provider on the device. This may include the use of cryptographic keys, such as public and/or private key pairs, a public key infrastructure (PKI) or other trust and/or security protocol and relationship. The data source may correspond to a certificate authority (CA) but may also correspond to other sources of application data and/or infrastructure components to be updated. As such, different application infrastructure needs may also be addressed in addition to or in place of digital certificates.

The data source and the application running on one or more of the devices (e.g., a copy of the application running on each separate device) may connect to the CA, controller, or other data source, or the data source may attempt to connect to one or more devices on or via the control plane. The control plan may correspond to a network component utilized to manage how data is routed and processed, as well as managed on the network, such as the mesh network of devices that may form a data mesh for exchange of data. The control plane may coordinate communications between different components, which may include the exchange of the digital certificates or other data to be updated. An update may be sent to the one or more devices connected to the data source, and the devices may receive and perform the updates. With digital certificates, this may include rotating old or expiring digital certificates to new certificates issued by the CA.

The devices may further use the mesh network to form secure communication tunnels or pathways between devices that may be used for the secure exchange of data. These tunnels may be created or established between the copies of the application running on the devices. In this regard, an application may correspond to a particular software application having a collection of operations, procedures, and the like that has been coded for one or more tasks and is encapsulated in a single (or set of) software programs, which may belong to or be provided by a service provider. The application may be downloaded on many different devices, each having a copy of the application (e.g., its files, code, etc.) residing on the device. When the application is executed, an instance of the application begins running on that particular device. This running instance of the application may connect to other devices and their corresponding running instances of their respective copies of the application. As such, it is understood that, when the application requires an update, each copy of the application being used by devices that have downloaded a copy of the application may require an update. This may be performed to cause each instance of the copy of the updated application on the device to utilize the latest updates, such as digital certificates, during application execution and runtime.

As such, a first copy of the application on a first device may receive the digital certificate for rotation or receive other data to be updated and/or utilized for application infrastructure maintenance (e.g., security policies/protocols, communication protocols, etc.). The application may then be updated to utilize the latest digital certificate or other updated data, for example, for secure tunnel establishment and to establish a zero-trust tunnel or other communication tunnel, bridge, or connection with one or more other devices on the mesh network. The certificate authority may perform the updates for each copy of the application until the next update is required and/or all devices (or all available devices that may be connected to the mesh network) are updated. Any device found to have a noncompliant or un-updated version of the application may be updated when detected by the CA, but may also be refused connection to and/or use of the mesh network for data exchange and/or use on the data mesh between devices and the copies of the application.

Therefore, the service provider's system may provide an automated application infrastructure management process, framework, and system designed to manage, update, and maintain certain application infrastructure components and requirements. By providing a controller on a mesh network to facilitate the exchange of updates and other maintenance of these components and requirements, such as to update digital certificates used for security protocols, time-consuming tasks may be automated, thereby freeing application development teams to focus on improving the core functionality of the applications. Further, the mesh network and automated controller for device updates may be run automatically and without requiring attention of users that may not timely perform updates or may introduce additional security concerns through their devices and other factors that may compromise data security. By utilizing a mesh network between devices, updates and certificate rotations may be performed independent of each individual device being updated by the central controller, and devices may perform updates in a more efficient and reliable manner. Therefore, a service provider may implement an improved computing system, framework, and processes that provide more efficient, optimized, and secure application infrastructure updates and maintenance.

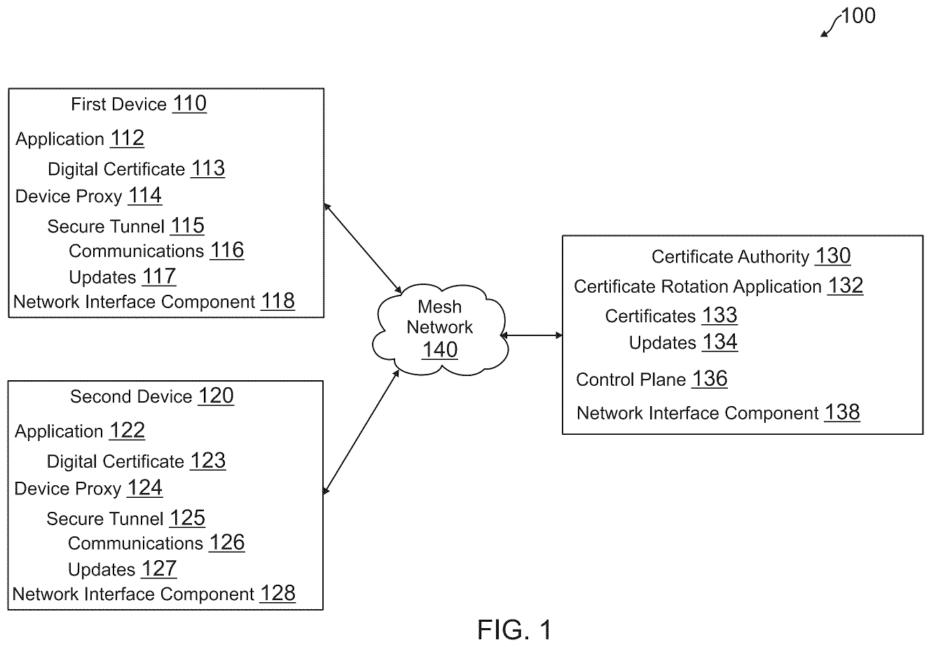

FIG. 1 is a block diagram of a networked system 100 suitable for implementing the processes described herein, according to an embodiment. As shown in FIG. 1, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes a first device 110, a second device 120, and a certificate authority 130 in communication over a mesh network 140. First device 110 and second device 120 may be utilized by a user, customer, or the like to access an application 112 and an application 122, respectively, for a computing service or resource provided by a service provider, which may utilize certificate authority 130 to perform application maintenance of application infrastructure data including digital certificates using mesh network 140. Certificate authority 130 may provide application 112/application 122 with various data, operations, and other functions via mesh network 140 for application updating, which may include performing certificate rotation of digital certificates. In this regard, certificate authority 130 may provide data maintenance and management by acting as a data source to push and/or provide updates and other data for maintaining application infrastructure of application 112/application 122.

First device 110, second device 120, and certificate authority 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over mesh network 140.

First device 110/second device 120 may be implemented as computing and/or communication devices that may utilize appropriate hardware and software configured for wired and/or wireless communication with certificate authority 130 and/or other devices and/or servers including one associated with application 112/122 for computing services provided by a service provider. For example, in one embodiment, first device 110/second device 120 may be implemented as a VM, a physical machine or PS directly running software (e.g., software on a server), or other non-cloud native device, server, or other machine that may not utilize containerized solutions for operating and executing instances of applications and instead may directly run instances of software. As such, each of first device 110 and second device 120 have a corresponding software workload being executed on the corresponding machine. Although two devices are shown interacting with certificate authority 130, a plurality of devices (e.g., 3 or more, such as a mesh network of hundreds or more devices, PSs, VMs, and the like) may function similarly and/or be connected to provide the functionalities described herein.

First device 110/second device 120 of FIG. 1 contains application 112/application 122, a waypoint or device proxy 114/124, a secure tunnel 115/125 and a network interface component 118/128. Application 112/application 122 may correspond to executable processes, procedures, and/or applications with associated hardware. In other embodiments, first device 110/second device 120 may include additional or different modules having specialized hardware and/or software as required.

Application 112/application 122 may correspond to one or more processes to execute software modules and associated components of first device 110/second device 120 to provide features, services, and other operations for a corresponding user over a network, which may include accessing and/or interacting with a service provider, other devices and/or users, and/or computing services. In this regard, application 112/application 122 may correspond to specialized software utilized by first device 110/second device 120 that may provide computing services and/or user interfaces over network 140 based on the features, operations, and services of application 112/application 122 (e.g., a computing service of a service provider that is accessible within a native software application). In various embodiments, application 112/application 122 may be utilized with mobile applications including mobile browser applications configured to retrieve, present, and communicate information over the Internet (e.g., utilize resources on the World Wide Web) or a private network. For example, application 112/application 122 may provide data to a user's mobile device and corresponding a mobile browser or other user interfaces, which enable the user's mobile device to access websites and send/receive information for application 112/application 122 over the Internet or other network, including retrieving website data (e.g., a website for a merchant), presenting website data to the user, and/or communicating information from application 112/application 122 to a website. However, in other embodiments, application 112/application 122 may be associated with and/or provided data and data processing operations for a dedicated or native software application of a service provider, merchant, or other entity provided on a device of a user, including mobile applications and other software applications resident on computing devices of users. As such, application 112/122 may correspond to instance of an application (from corresponding copies of that application) that are being executed on a physical device or PS or a VM, and as such may be provided by a service provider and/or utilized with computing services of the service provider that is associated with certificate authority 130 and may utilize certificate authority 130 for infrastructure maintenance and updating.

Application 112/application 122 may be associated with electronic transaction processing including providing and/or utilizing account information, user financial information, and/or transaction histories. As such, application 112/122 may be used to process transactions and/or utilize payment and transaction processing services with a transaction processor or other service provider. However, in further embodiments, different services may be provided via application 112/application 122, including messaging, social networking, media posting or sharing, microblogging, data browsing and searching, online shopping, and other services available through certificate authority 130. When using application 112/application 122, infrastructure components and/or data may be used, which may include security protocols, secrets, encryption keys, digital certificates 113/123, and the like for secure application communications, data exchanges, and processing. For example, certificate authority 130 may periodically perform a certificate rotation that updates digital certificates 113/123 to the newest, most recent, or updated version of digital certificates 113/123 having a current password or other secret to be used. As such, by updating digital certificates 113/123, authorization for application 112/122 may be kept updated and current so that application 112/122 may function appropriately and be trusted for secure interactions with other applications and endpoints.

Other infrastructure components utilized for application functionality and usage may also require maintenance including data for different application features that may be updated periodically or when new data is available and/or provided by the service provider. As such, application 112/122 may utilize waypoint or device proxy 114/124 and/or secure tunnel 115/125 to engage with other devices, servers, and data sources over mesh network 140 including certificate authority 130. For example, first device 110 may establish a secure tunnel 115 with certificate authority 130 and/or application 122 on second device 120 using application 112 and waypoint or device proxy 114. Secure tunnel 125 established by second device 120 using application 122 and waypoint proxy or device 124 may correspond to another similar secure communication tunnel, channel, pathway, or other communication exchange, which may be established to further distribute digital certificate 113/123 to additional devices over mesh network 140. Secure tunnel 115/125 may utilize a mutual Transport Layer Security (mTLS) protocol for encryption and security of data communications, which may be connected using Hypertext Transfer Protocol Secure (HTTPS) CONNECT method requests and tunnels that allow a TLS or mTLS connection to be established through a proxy (e.g., waypoint or device proxy 114/124).

Secure tunnels 115/125 may be established on a data plane corresponding to mesh network 140 and may be used to exchange communications 116/126. Communications 116/126 may be used to establish a shared secret and/or zero-trust tunnel for secure tunnels 115/125 and may be conducted using the security protocol for establishment of secure tunnels 115/125. Communications 116/126 may further provide data necessary for zero-trust tunnels to be maintained and for updates 117/127 to be sent and/or received via secure tunnels 115/125. As such, when updates 117/127 are exchanged in a secure manner through the security protocol, secure tunnels 115/125 may be used to update digital certificates 113/123 based on updates 117/127. Updates 117/127 may be received and/or requested to be performed by certificate authority 130. In some embodiments, application 112/application 122 may be used to provide one or more interfaces to opt-in to consent and authorizations for application updates and infrastructure changes using mesh network 140 with certificate authority 130. As such, the consent may be provided via an in-application process and may be stored device-side and/or with certificate authority 130.

First device 110/second device 120 may further include databases stored on a transitory and/or non-transitory memory of first device 110/second device 120, which may store various applications and data and be utilized during execution of various modules of first device 110/second device 120. Databases may include, for example, identifiers such as operating system registry entries, cookies associated with application 112/application 122 and/or other applications, identifiers associated with hardware of first device 110/second device 120, or other appropriate identifiers, such as identifiers used for payment/user/device authentication or identification, which may be communicated as identifying the user/first device 110/second device 120 to certificate authority 130.

First device 110/second device 120 includes at least one network interface component 118/128 adapted to communicate with certificate authority 130 and/or other devices, servers, and endpoints. In various embodiments, network interface component 118/128 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Certificate authority 130 may be maintained, for example, by an online service provider that provides native software applications including application 112/122, as well as data and/or content accessible via application 112/application 122 over a network. In this regard, certificate authority 130 may be accessible over mesh network 140 by application 112/122 and usable by the service provider to perform updates and/or maintenance of application infrastructure. In this regard, certificate authority 130 includes one or more processing applications which may be configured to interact with first device 110/second device 120 and/or other internal and/or external computing services to provide and serve updates to application 112/application 122, which may include updating and/or rotating digital certificate 113/123 on devices on and/or utilizing mesh network 140. In one example, certificate authority 130 may be provided by PAYPAL®, Inc. of San Jose, CA, USA. However, in other embodiments, certificate authority 130 may be maintained by or include another type of service provider.

Certificate authority 130 of FIG. 1 includes a certificate rotation application 132, a database, and a network interface component 138. Certificate rotation application 132 on certificate authority 130 may include executable processes, procedures, and/or modules with associated hardware used to provide a website over mesh network 140 that may be accessible by various web browsers. In other embodiments, certificate authority 130 may include additional or different modules having specialized hardware and/or software as required.

Certificate rotation application 132 may correspond to one or more online resources acting as a data source to provide features, services, and other operations for updating application infrastructure components and data on application 112/application 122 over mesh network 140, such as to update digital certificate 113/123 on first device 110/second device 120 for use with security requirements and protocols using certificates 133. As such, certificate rotation application 132 may provide certificates 133 for updating corresponding information, computing services, security protocols, features, and the like for copies of an application provided by a service provider. In some embodiments, certificate rotation application 132 may be hosted, provided by, and/or utilized by an online and/or application service provider that provides computing services to users via copies of an application provided on their respective user devices. For example, the copies of the application may correspond to application 112/122 on first device 110 and second device 120.

In this regard, certificate rotation application 132 may be utilized to maintain and update infrastructure for the application provided by the service provider through certificate rotation and/or updating of certificates 133 over mesh network 140. Certificate rotation application 132 may be used to execute and/or perform updates 134 based on an update schedule or other update requirements of the service provider and/or for the copies of the application on different devices including first device 110/second device 120 (e.g., application 112/122). Certificate rotation application 132 may provide a control plane 136, which may correspond to a plane or part of a network topology on which mesh network 140 resides or is provided. In this regard, control plane 136 may be responsible for establishing and defining the exchange of data packets over mesh network 140, with may include providing routing protocols and paths for data exchange between the devices on mesh network 140. In some embodiments, control plane 136 may be provided and/or established on different applications through operations, software development kits (SDKs), API standards or guidelines, and the like that may be provided by the service provider. Control plane 136 may be used to coordinate data communications on a data plane that is used by the devices on or using mesh network 140, such as for first device 110 and second device 120 to establish and use secure tunnel 115 and secure tunnel 125, respectively, to perform updates 134 of certificates 133 on each corresponding device.

Certificate rotation application 132 may be utilized by the service provider to perform the certificate rotations of certificates 133 based on a schedule, requirement, request, or other trigger for updates 134. In this regard, when certificates 133 require rotation, control plane 136 may be used to establish a connection with a computing device and transmit data for a new digital certificate to replace or refresh the existing and/or expiring digital certificate. In one example, this may include first device 110 establishing a secure communication channel or tunnel, such as secure tunnel 115 with certificate authority 130 so that the digital certificate may be securely provided to first device 110 via communications 116, which may initiate updates 117 of digital certificate 113. In this regard, control plane 136 may be responsible for how data is managed, routed, and processed on mesh network 140. Waypoint or device proxy 114/124 may be used as waypoint proxies that may be configured by control plane 136 and/or injected to function with secure tunnel 115/125 and pass data through such proxies when handling workloads associated with performing updates 134 for certificates 133.

In order to further complete the certificate rotation, certificate rotation application 132 of certificate authority 130 may be used to update digital certificate 123 on second device 120 through control plane 136 using secure tunnel 115/125 and waypoint or device proxy 114/124. For example, secure tunnel 125 may be established by certificate authority 130 with first device 110 and second device 120 by a subroutine or other process of application 112/122 that connects with other devices on the data plane of mesh network 140 for data exchange and communication. Secure tunnel 125 may be established based on instructions for updates 134 of certificates 133 that are performed with control plane 136 so that the copies of the application are updated. In this manner, waypoint proxy 124 may be injected into a pathway of secure tunnel 125 so that when secure tunnel 125 exchanges data via communications 126 for performing updates 127, waypoint proxy 124 may be used for handling and/or processing workloads associated with the local node of second device 120, but may not be required to function as a proxy (e.g., a sidecar proxy) on the device itself. Waypoint proxy 114/124 may therefore function as a shared namespace resource that is accessible and/or utilizable by first device 110/second device 120 and may be scaled independently from the corresponding device and resource usage on the device.

Secure tunnel 125 may be used by second device 120 to receive the workload and/or request for certificate rotation of digital certificate 123 from certificate authority 130 based on updates 127. Waypoint or device proxy 114/124 may provide processing for a workload to a node, such as first device 110 and/or second device 120, but is not necessarily guaranteed to be located on such node and may instead be inserted into and/or with secure tunnel 115/125 for workload processing during updates 117/127 being performed by each device, such as when updates 134 are performed for certificates 133 by certificate rotation applications 132. Thus, mesh network 140 may be used for certificate rotation by certificate authority 130, freeing up an application team from performing application updates for infrastructure requirements.

Additionally, certificate authority 130 may include a database. The database may store various identifiers associated with certificate authority 130. Certificates 133, updates 134, and other infrastructure management data may be stored by the database. Although the database is discussed as residing on or with certificate authority 130, in other embodiments, other types of data storage and components may be used including cloud computing storage nodes, remote data stores and database systems, distributed database systems over mesh network 140 and/or of a computing system associated with certificate authority 130, and the like.

Certificate authority 130 may include at least one network interface component 138 adapted to communicate first device 110/second device 120 and/or other devices, servers, and the like directly and/or over mesh network 140. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Mesh network 140 may be implemented as a single network of devices that provide communication controlled by control plane 136 and/or similar network topology but may also correspond to a combination of multiple networks. For example, in various embodiments, mesh network 140 may be provided over the Internet or one or more intranets, landline networks, wireless networks, and/or other appropriate types of networks. Thus, mesh network 140 may be provided over a small-scale communication network, such as a private or local area network, or a larger scale network, such as a wide area network or the Internet, accessible by the various components of system 100.

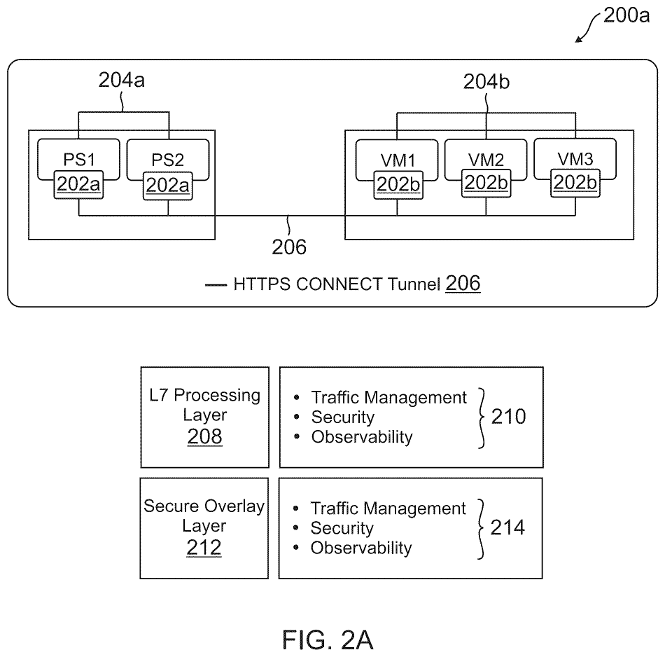

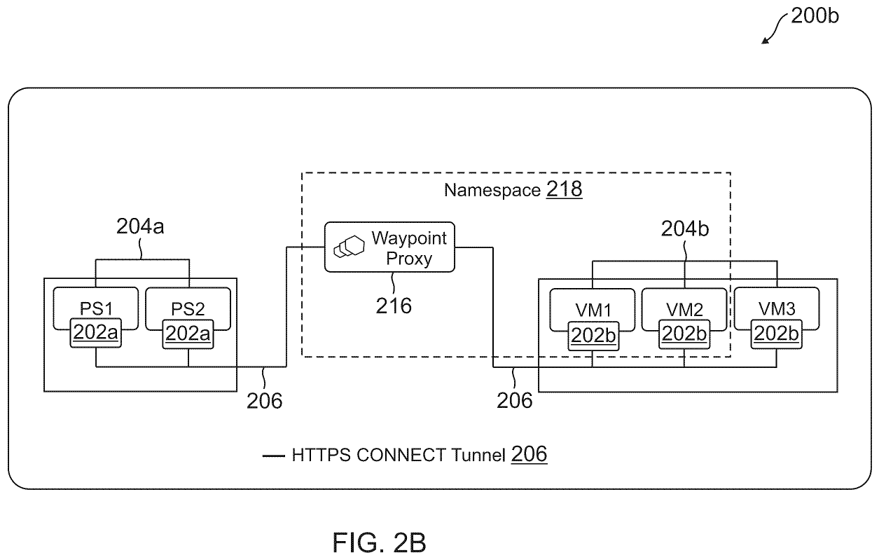

FIGS. 2A and 2B are exemplary diagrams 200a and 200b of secure tunnels establishment and usage between machines on a mesh network for application management and updates, according to an embodiment. Diagrams 200a and 200b include components referenced with regard to system 100 of FIG. 1, such as the components of certificate authority 130 interacting with first device 110 and/or second device 120 over mesh network 140 to provide certificate rotation or other application infrastructure updates to application 112 and/or application 122 in accordance with updates 134 to certificates 133 and the like. In this regard, diagrams 200a and 200b show representations of secure tunnel establishment and usage for secure data exchange. Further, diagrams 200a and 200b show representations of a certificate rotation or other infrastructure maintenance to software application components and data performed via a control plan.

In diagram 200a, an example of secure tunnel establishment and usage, such as zero-trust tunnel or “ztunnel” establishment and usage, between nodes of a mesh network or other data mesh of devices is shown. A ztunnel 202a and a ztunnel 202b may each be created for the purposes of exchanging data on a data plane. Ztunnels 202a and 202b may be established with a zero-trust policy for node proxies in the data mesh shown in diagram 200a, such that ztunnels 202a and 202b may provide for secure data transport. In this regard, ztunnel 200a/200b may securely connect to other ztunnels and nodes including the nodes in PSs 204a and VMs 204b (e.g., a bare-metal physical server or VM running software directly and having a software workload where the server does not serve multiple instances of different applications as would devices in a cloud computing environment) of one or more computing devices. Ztunnel 202a/202b may securely connect and authenticate workloads using the zero-trust policy where no implicit trust is provided to other devices or nodes, and each device or node may only be given access to the minimum to which that device or node requires for performing their task or processing their workload, which may be based on the authentication or verification provided.

The zero-trust policy may be established for the security policy and may require that ztunnels 202a and 202b be connected through an HTTPS CONNECT tunnel 206 or other connection that may be performed by a proxy. Establishing the connection may include providing a digital certificate for the security policy that may allow establishment of HTTPS CONNECT tunnel 206 between ztunnels so that data may be exchanged between clusters and nodes for digital certificate rotation. With ISTIO™, for the data plane shown in diagram 200a, an L7 processing layer 208 having policies 210 may be provided in addition to a secure overlay layer 212 with policies 214 for the data plane shown in diagram 200b. For example, with ISTIO™, policies 214 for secure overlay layer 212 may include TCP routing for traffic management, mTLS tunneling and simple authorization policies for security, and TCP metrics and logging for observability. However, ISTIO™ Ambient Mesh may further provide, for a data mesh similar to that shown in diagram 200a, policies 210 for L7 processing layer 208 that include HTTP routing and load balancing, circuit breaking, rate limiting, fault injection, retry, timeout, and the like for traffic management, rich authorization policies for security, and/or HTTP metrics, access logging, and tracing for observability. In this regard, the data mesh shown in diagram 200a may provide for a secure environment for secure data communications between devices that may be provided through ztunnels 202a and 202b with HTTPS CONNECT tunnel 206. Further, a control plane of that data mesh may be used to perform updates and other application infrastructure maintenance on or between PSs 204a (e.g., PS1, PS2, etc.) and VMs 204b (e.g., VM1, VM2, VM3, etc.).

In diagram 200b, establishment of a waypoint proxy 216 is shown with regard to injection in or between ztunnels 202a and 202b. For example, when performing or managing workloads, waypoint proxy 216 may assist in workload handling, management, and processing. Waypoint proxy 216 may handle L7 processing workloads in a namespace 218 for that workload. A control plane may configure ztunnels 202a and 202b to pass traffic that requires L7 processing designated by namespace 218, or other layer processing for the corresponding namespace, through waypoint proxy 216 such that waypoint proxy 216 may perform the corresponding workload handling and processing that has been designated. In this regard, waypoint proxy 216 in namespace 218 may reside on a node that does not necessarily need to be the same node or device associated with ztunnels 202a and 202b, and may therefore be automatically scaled as needed for the corresponding update or other infrastructure management operation and task.

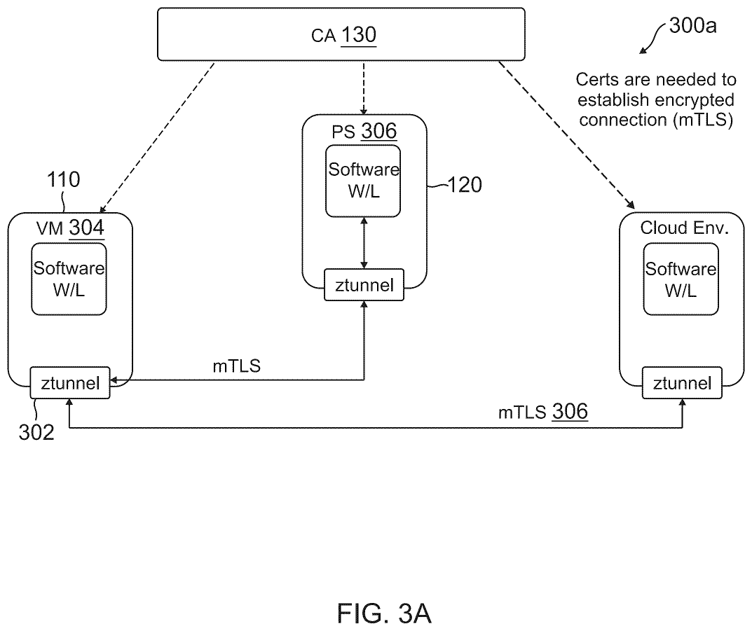

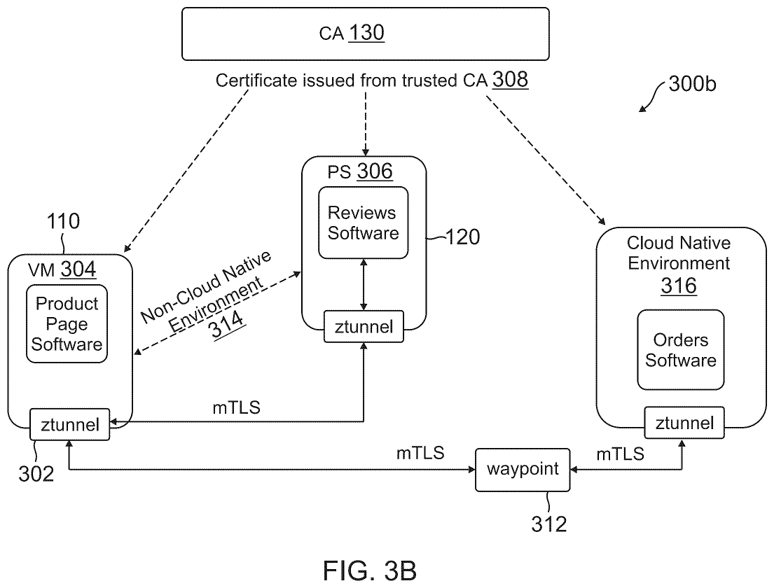

FIGS. 3A and 3B are exemplary system architectures 300a and 300b where digital certificates for security protocols and data are updated on machines for a software application managed through a control plane of a mesh network, according to an embodiment. System architectures 300a and 300b may include components and data referenced with regard to system 100 of FIG. 1, such as the components of certificate authority 130 interacting with first device 110/second device 120 over mesh network 140 to provide application 112/application 122 with data for certificate rotation and/or other application infrastructure maintenance. In this regard, system architectures 300a and 300b show representations of a certificate rotation of the certificates needed for mTLS communications between endpoints including between the devices on the data mesh shown in system architectures 300a and 300b, such as an ISTIO™ data mesh that provides a mesh network of devices through an ISTIO™ Ambient Mesh.

In system architecture 300a, first device 110 may establish and provide a ztunnel 302 for connection via an HTTPS CONNECT communication tunnel or pathway to second device 120. In this regard, first device 110 may correspond to a VM 304 on the mesh network that may perform updating of certificates necessary for mTLS communications with second device 120 through their corresponding ztunnel. Second device 120 may correspond to a PS 306 on the mesh network as well. As such, VM 304 and PS 306 may correspond to separate, non-cloud native environments executing software workloads directly and, as such, do not have containerized solutions that can be used for application updates, such as certificate rotations by certificate authority 130. As such, certificate authority 130 may issue a certificate for rotation by first device 110 and second device 120 on the mesh network, which may seek to perform an automated certificate rotation using the control mesh, such as the ISTIO™ Ambient Mesh. Certificate authority 130 may provide a control plane by which first device 110 providing, running an instance of, or otherwise executing VM 304 may be updated with a new or updated digital certificate during a certificate rotation.

In this regard, VM 304 may establish ztunnel 302 based on instructions and other configurations by certificate authority 130 via the control plane. Ztunnel 302 may be established on the data plane for the mesh network, and may connect using mTLS 306 for encrypted communications. mTLS 306 may utilize existing digital certificates, which may be required to be updated so that ztunnels may be established and/or other secure and encrypted communications may be exchanged. In this regard, PS 306 may have a corresponding ztunnel and may receive data for the new digital certificate that is to be updated and/or rotated into usage, and may perform the corresponding update to the copy of the application residing on second device 120.

In system architecture 300b, a certificate issuance 308 during an auto-certificate rotation 310 is performed by certificate authority 130, which may be used to rotate new digital certificates into usage. Further, system architecture 300b shows a certificate rotation and interactions between a non-cloud native environment 314, such as an environment where VM 304 on first device 110 and PS 306 corresponding to second device 120 provide direct software workload execution, may interact with a cloud native environment 316 during certificate rotation. As such, a command, request, or other update and/or certificate rotation process is initiated in the control plane for the mesh network in system architecture 300b when certificate issuance 308 is performed. Certificate issuance 308 causes auto-certificate rotation 310 to rotate a new digital certificate into usage, which updates the corresponding data, such as by placing and/or storing a new version or copy of the newly issued digital certificate, on first device 110.

In non-cloud native environment 314, first device 110 executing or providing VM 304 for a product page software workload establishes ztunnel 302 on the data plane. VM 304 may utilize ztunnel 302 for secure communications with other nodes including other copies of the application. To perform workload processing, waypoint proxy 312 may be established between ztunnel 302 and a corresponding ztunnel. Communications may be exchanged via mTLS 306 with waypoint proxy 312, which may then allow for waypoint proxy to receive the workload instructions and/or data for the corresponding network layer and perform workload handling and processing to utilize the other node.

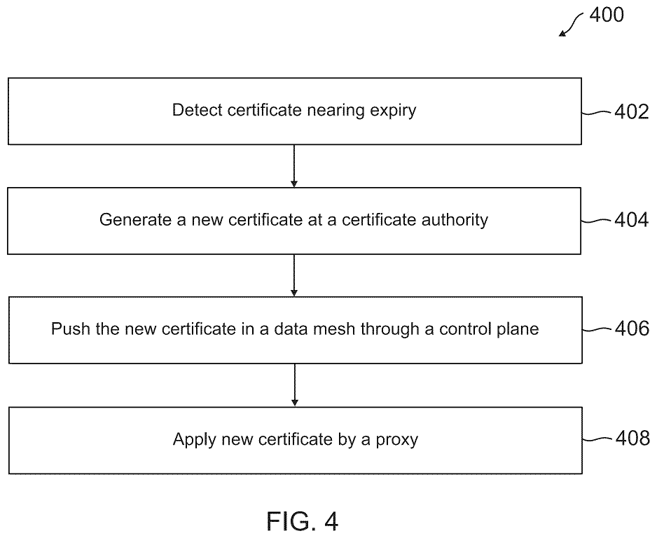

FIG. 4 is a flowchart 400 showing operations for management of applications and application infrastructure through a control plane for a mesh network of devices, according to an embodiment. Note that one or more steps, processes, and methods described herein of flowchart 400 may be omitted, performed in a different sequence, or combined as desired or appropriate.

Initially, at a step 402 of flowchart 400, a certificate nearing expiry is detected. In system 100, certificate authority 130 may receive or be configured to perform updates 134 at a particular time or based on a schedule, periodic or repeating rotation, or amount of time until expiration of the corresponding one of certificates 133. In this regard, the certificate rotation may be performed to update, refresh, and/or rotate out expiring digital certificates or those that are no longer valid, have expired, or those that have passwords, secrets, or the like that have been compromised or changed for a security protocol. The digital certificate may be used by an application for a security protocol and/or secure password or secret used for certain communications. As such, certificate authority 130 may monitor different certificate expirations, and a certificate rotation may be triggered when a certificate is nearing expiration.

At step 404, a new certificate is generated at a certificate authority. To perform the certificate rotation, certificate authority 130 may generate a new certificate or may update an existing certificate for further use with secure communications. In this regard, a security protocol may be determined for encrypted communications between the devices on the mesh network using secure communication tunnels with proxies for workload processing. For example, with mutual Transport Layer Security (mTLS) protocols for data security, an mTLS certificate may be required to be updated, which may be done through a certificate rotation by certificate authority 130. The mTLS certificate may be used with a security policy and/or protocol that further uses a secure overlay layer and a zero-trust policy for data exchanges and communications. For example, one or more layers utilizing the zero-trust policy for secure tunnel establishment data communications may be provided by the security protocol, which may utilize the digital certificates during data communications and processing between applications, endpoints, and devices. As such, an mTLS certificate may be generated for the corresponding security protocol, however, other applications may utilize other protocols and/or data to be updated in the manner described herein. Thus, the security protocol may be utilized by the application of the service provider and may require a digital certificate rotation or other infrastructure updates to separate copies of the application.

At step 406, the new certificate is pushed in a data mesh through a control plane. The new certificate may be required for secure communication tunnels, which may be provided and established using HTTPS CONNECT, or other method that requests a proxy establish an HTTPS tunnel to a destination device, server, node, or other endpoint. HTTPS CONNECT method of communication tunnel, pathway, or other connection may be used with mTLS certificates and/or protocol for secure TLS connections, as well as zero-trust tunnels or ztunnels. As such, the digital certificate may be designated by a security protocol for the secure communication tunnel establishment, and may require periodic, scheduled, or designated certificate rotations to rotate in new and/or update digital certificates to maintain a desired level of security and trust between devices.

To push the new certificate and perform the certificate rotation, a server or other device is communicated with by certificate authority 130 (e.g., data source performing the update) via control plane 136 for verification of the digital certificate on the device and determination of an expiration time of the digital certificate. The digital certificate may be pushed to a ztunnel, a sidecar proxy, or a waypoint, depending on the mode of the data mesh. When performing a certificate rotation by certificate authority 130, digital certificate 113/123 on each device and/or for each application to be updated may be verified to be legitimate and/or expiring so that certificate authority 130 may determine that updates 134 are required and/or should be performed to rotate certificates 133 for the copies of the application. This enables maintaining the application infrastructure necessary for application functionalities and/or availability of application operations and interactions of the application with other applications, devices, and the like. For example, the application infrastructure may correspond to security protocols and/or authentication/verification data used by the application during data communications and processing, which may verify the copy of the application for requests and data processing.

At step 408, the new certificate is applied by a proxy. Certificate rotation application 132 may perform updates 134 of certificates 133 to update and/or rotate between each digital certificate and ensure expiring digital certificates on devices, such as digital certificate 113/123 reaching an expiration time or invalidity trigger, threshold, or time, does not impact application performance and functionality. Thus, digital certificate 113/123, when determined to be valid but expiring at step 408, may be updated through a push of the new digital certificate at step 406, which is then applied by device proxy 114/124. Performance of the certificate rotation may be done through instructions and/or coordination via control plane 136. Device proxy 114/124 may swap in and apply the new digital certificate to update the application for use of the new digital certificate for secure communications. This allows for seamless mTLS use for secure communications using the updated certificate without downtime or application team oversight for certificate rotations.

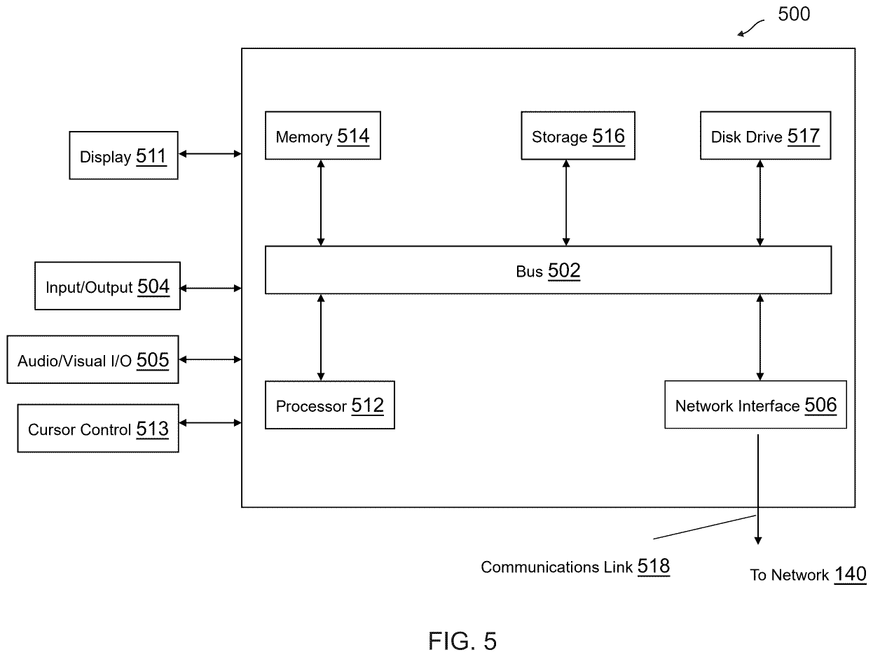

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via mesh network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
determining a mesh network of devices that execute corresponding copies of an application managed by a control plane of the mesh network;
receiving an update to the application;
identifying a security protocol for encrypted communications transmissible between each of the devices using secure communication tunnels, wherein the security protocol enables a mutual authentication to be performed between each of the devices and connect two or more of the devices via one or more of the secure communication tunnels based on the mutual authentication;
connecting with one or more of the devices via a first one of the one or more secure communication tunnels using the security protocol;
obtaining data for the update from a data source; and
updating the one or more of the devices using the data.

2. The system of claim 1, wherein the devices comprise at least one of virtual machines (VMs) or physical servers that directly run the application in a non-cloud computing environment, and wherein the update comprises a renewal of a digital certificate associated with the security protocol of each of the one or more of the devices.

3. The system of claim 2, wherein the updating the one or more of the devices comprises:
checking an expiration time of a version of the digital certificate on each of the one or more of the devices;
determining that the renewal is required prior to the expiration time; and
rotating the version of the digital certificate to a more recent version of the digital certificate on each of the one or more of the devices using the data for the update.

4. The system of claim 1, wherein the obtaining the data comprises:
connecting with the data source and one of the secure communication tunnels;
verifying the data source;
receiving the data for the update from the verified data source via a proxy; and
performing the update of the data using the proxy, wherein the proxy provides workload processing for the update of the data.

5. The system of claim 1, wherein the data source comprises a rotating certificate authority, and wherein the obtaining the data is from a control plane of the rotating certificate authority via one of the secure communication tunnels responsive to an issuance of the data for the update by the rotating certificate authority.

6. The system of claim 1, wherein the updating the one or more of the devices using the data comprises:
distributing, using the data, the update to the data through the more or more secure communication tunnels.

7. The system of claim 1, wherein the security protocol comprises mutual Transport Layer Security (mTLS) and the update comprises an issued mTLS certificate, and wherein each of the secure communication tunnels utilizes a proxy for workload processing and connects to a control plane for the data source, and wherein the control plane manages the workload of the proxy and traffic through the data plane between other ones of the devices using the secure communication tunnels.

8. The system of claim 1, wherein the system is one of the devices on the mesh network, and wherein the receiving the update comprises:
connecting to the data source;
detecting an issuance of the update by the data source; and
determining that corresponding data for the update requires updating before an expiration time of the corresponding data has been reached.

9. The system of claim 8, wherein the updating the one or more of the devices is based on expiration times of the corresponding data on the one or more of the devices.

10. A method comprising:
receiving, by a first device on a mesh network for a plurality of devices, data for updating an application on the plurality of devices from a certificate authority, wherein each of the plurality of devices has a separate copy of the application installed, wherein the data includes a digital certificate issued from the certificate authority to be updated on the plurality of devices from a control plane of the mesh network;
updating, on the first device, the digital certificate based on the data and a request to update the data on the first device;
determining, by the first device, a security protocol enabling encrypted communications to be transmitted via a communication tunnel with a second device of the plurality of devices;
performing, by the first device, an authentication with the second device using the security protocol using the updated digital certificate; and
connecting, by the first device, with the second device via the communication tunnel on a data plane of the mesh network based on the authentication.

11. The method of claim 10, wherein the mesh network includes a waypoint proxy configured to swap in the digital certificate for an expiring digital certificate on the first device.

12. The method of claim 11, wherein the waypoint proxy provides workload processing for the first device including swapping in the digital certificate for use with the encrypted communications.

13. The method of claim 11, wherein the waypoint proxy is provided by a processing node on the mesh network.

14. The method of claim 11, wherein the waypoint proxy is provided in a namespace for a layer of the mesh network associated with a workload to be processed by the waypoint proxy.

15. The method of claim 10, wherein the connecting with the second device uses a Hypertext Transfer Protocol Secure (HTTPS) CONNECT tunnel for an establishment of the communication tunnel on the data plane.

16. The method of claim 15, wherein the HTTPS CONNECT tunnel utilizes a mutual Transport Layer Security (mTLS) protocol for the encrypted communications.

17. The method of claim 10, wherein the communication tunnel uses a zero-trust policy for the security protocol.

18. A non-transitory machine-readable medium having stored thereon machine-readable instructions executable to cause a machine to perform operations comprising:
receiving, by a first device on a mesh network for a plurality of devices, a request to perform a certificate rotation of a first digital certificate on the first device;
performing the certificate rotation that updates the first digital certificate to a second digital certificate having an expiration time after the first digital certificate for an application on the first device;
determining a security protocol and an authentication with the second device using the security protocol, wherein the security protocol utilizes the second digital certificate after the certificate rotation for encryption communications with the plurality of devices; and
establishing a secure communication connection by the first device with a second device of the plurality of devices.

19. The non-transitory machine-readable medium of claim 18, wherein a proxy is provided by a control plane with the secure communication connection, and wherein the proxy is configured to apply the second digital certificate to the application after the certificate rotation.

20. The non-transitory machine-readable medium of claim 18, wherein the request for the certificate rotation is received from a certificate authority based on an expiration time of the first digital certificate.
